(19) United States
(12) Patent Application Publication
(10) Pub. No.: US 2026/0028123 A1
(43) Pub. Date: Jan. 29, 2026

(54) AIRCRAFT SEATBACK TRAY TABLE MODULE

(71) Applicant: B/E Aerospace, Inc., Winston-Salem, NC (US)

(72) Inventor: Glenn A. Johnson, Rural Hall, NC (US)

(21) Appl. No.: 18/782,857

(22) Filed: Jul. 24, 2024

(51) Int. Cl. B64D 11/06; B64D 11/00

(52) U.S. Cl. CPC B64D 11/0638; B64D 11/00152

(57) ABSTRACT

A modular seatback table module may include a modular body with a plurality of internal walls, where the plurality of internal walls may at least partially define an interior cavity. The seatback table module may include a deployable tray table configured to actuate between a tray table stowed position and a tray table deployed position, where at least a portion of the interior cavity of the modular body may be configured to receive at a portion of the deployable tray table when the deployable tray table is in the tray table stowed position. The seatback table module may include one or more tray table actuation members configured to couple to one or more mount points integrated on the modular body, where the one or more tray table actuation members may be configured to actuate the deployable tray table between the tray table stowed position and the tray table deployed position.

### TECHNICAL FIELD

The subject matter disclosed herein relates to aircraft seats and, in particular, an aircraft seatback tray table module.

### BACKGROUND

Often aircraft cabins utilize a variety of aircraft seat sizes throughout the aircraft cabin due to spacing constraints within the cabin. Due to the variety of aircraft seat sizes, different in-flight entertainment (IFE) device and tray table designs are needed for each aircraft seat. This makes the manufacturing process more complex, increases part count, and thus increases cost.

### SUMMARY

A modular seatback tray table module is disclosed, in accordance with one or more embodiments of the disclosure. In embodiments, the modular seatback table module includes a modular body with a plurality of internal walls at least partially defining an interior cavity. The modular seatback table module also includes a deployable tray table configured to actuate at least between a tray table stowed position and a tray table deployed position. At least a portion of the interior cavity of the body is configured to receive at least a portion of the deployable tray table when in the stowed position. The modular seatback table module also includes one or more tray table actuation members configured to couple to one or more mount points integrated on the body. The tray table actuation members are configured to actuate the deployable tray table between at least one of the tray table stowed position and the tray table deployed position.

In some embodiments, the body of the modular seatback tray table module may be mounted to a portion of an aircraft seat.

In some embodiments, the modular seatback tray table module may be mounted to a fixed seatback of an aircraft seat.

In some embodiments, the tray table actuation members may include one or more hinges. The deployable tray table may be configured to actuate about a hinge axis between at least one of the tray table stowed position and the tray table deployed position.

In some embodiments, the deployable tray table may include a primary surface and one or more auxiliary surfaces.

In some embodiments, the one or more auxiliary surfaces may include one or more deployable extension members. The deployable extension members may include one or more table actuators. The table actuators may be configured to couple the primary surface to the one or more deployable extension members.

In some embodiments, the one or more deployable extension members may be configured to actuate between a first position and second position about a second axis of one of the table actuators, forming a wide tray table surface.

In some embodiments, the one or more deployable extension members may include a first extension member and a second extension member.

In some embodiments, the length of the first extension member and a length of the second extension member may be configured to cause a length of the wide surface of the deployable tray table to be substantially proportional to a length of a seatback of an aircraft seat.

In some embodiments, the modular seatback table module may include a personal electronic device configured to actuate between at least one of a support stowed position and a support deployed position via one or more support actuators.

In some embodiments, the modular seatback table module may include an indentation set within the body. The indentation may be configured to receive at least a portion of the personal electronic device support in the support position. The personal electronic device support may sit substantially flush with a surface of the modular seatback table module in the support position.

In some embodiments, the personal electronic device support may be configured to hold a personal electronic device when the personal electronic device support is in the support deployed position.

In some embodiments, the personal electronic device may include a mobile device or a smart tablet.

In some embodiments, the modular seatback table module may include one or more tray table locks. The tray table locks may be configured to stow the deployable tray table in the stowed position.

In some embodiments, the tray table locks may comprise one or more slidable latches.

In some embodiments, at least one of the body of the modular seatback table module or the deployable tray table may include one or more universal serial bus ports.

In some embodiments, at least one of the body of the modular seatback table module or the deployable tray table may include an information panel.

In some embodiments, the information panel may include a display screen. The display screen may be configured to one or more graphical icons.

In some embodiments, the graphical icons may include at least one of a fasten seatbelt icon, a no smoking icon, wireless fidelity information, flight status, or seat location.

An aircraft seat is disclosed, in accordance with one or more embodiments of the disclosure. In embodiments, the aircraft seat includes a seating section with a seat pan and a seatback. The seatback is a fixed seatback. The aircraft seat also includes a modular seatback module. In embodiments, the modular seatback table module includes a modular body with a plurality of internal walls at least partially defining an interior cavity. The modular seatback table module also includes a deployable tray table configured to actuate at least between a tray table stowed position and a tray table deployed position. At least a portion of the interior cavity of the body is configured to receive at least a portion of the deployable tray table when in the stowed position. The modular seatback table module also includes one or more tray table actuation members configured to couple to one or more mount points integrated on the body. The tray table actuation members are configured to actuate the deployable tray table between at least one of the tray table stowed position and the tray table deployed position. The modular seatback table module is coupled to the seatback.

This Summary is provided solely as an introduction to subject matter that is fully described in the Detailed Description and Drawings. The Summary should not be considered to describe essential features nor be used to determine the scope of the Claims. Moreover, it is to be understood that both the foregoing Summary and the following Detailed Description are examples and explanatory only and are not necessarily restrictive of the subject matter claimed.

### BRIEF DESCRIPTION OF THE DRAWINGS

The detailed description is described with reference to the accompanying figures. The use of the same reference numbers in different instances in the description and the figures may indicate similar or identical items. Various embodiments or examples (“examples”) of the present disclosure are disclosed in the following detailed description and the accompanying drawings. The drawings are not necessarily to scale. In general, operations of disclosed processes may be performed in an arbitrary order, unless otherwise provided in the claims. In the drawings:

FIG. 1A illustrates a simplified schematic of a modular seatback tray table module in a stowed tray table position, in accordance with one or more embodiments of the disclosure.

FIG. 1B illustrates a simplified schematic of the modular seatback tray table module in an intermediate tray table position, in accordance with one or more embodiments of the disclosure.

FIG. 1C illustrates a simplified schematic of the modular seatback tray table module in a deployed tray table position, in accordance with one or more embodiments of the disclosure.

FIG. 1D illustrates a simplified schematic of the modular seatback tray table module in the deployed tray table position with one or more deployable extension members in the first position, in accordance with one or more embodiments of the disclosure.

FIG. 1E illustrates a simplified schematic of the modular seatback tray table module with the deployed tray table position with one or more deployable extension members in a position between the first and second position, in accordance with one or more embodiments of the disclosure.

FIG. 2A illustrates a simplified schematic of a deployable tray table of the modular seatback tray table module in the deployed tray table position, in accordance with one or more embodiments of the disclosure.

FIG. 2B illustrates a simplified schematic of the deployable tray table in the deployed tray table position, in accordance with one or more embodiments of the disclosure.

FIG. 3A illustrates a simplified schematic of the modular seatback tray table module including a personal electronic device (PED) support in a deployed PED position, in accordance with one or more embodiments of the disclosure.

FIG. 3B illustrates a simplified schematic of the modular seatback tray table module including the PED support in the deployed PED position, in accordance with one or more embodiments of the disclosure.

FIG. 3C illustrates a simplified schematic of the modular seatback tray table module including the PED support in the deployed PED position, in accordance with one or more embodiments of the disclosure.

### DETAILED DESCRIPTION OF THE INVENTION

Reference will now be made in detail to the subject matter disclosed, which is illustrated in the accompanying drawings.

Before explaining one or more embodiments of the disclosure in detail, it is to be understood the embodiments are not limited in their application to the details of construction and the arrangement of the components or steps or methodologies set forth in the following description or illustrated in the drawings. In the following detailed description of embodiments, numerous specific details may be set forth in order to provide a more thorough understanding of the disclosure. However, it will be apparent to one of ordinary skill in the art having the benefit of the instant disclosure the embodiments disclosed herein may be practiced without some of these specific details. In other instances, well-known features may not be described in detail to avoid unnecessarily complicating the instant disclosure.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the disclosure in any way unless expressly stated to the contrary.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” may be employed to describe elements and components of embodiments disclosed herein. This is done merely for convenience and “a” and “an” are intended to include “one” or “at least one,” and the singular also includes the plural unless it is obvious that it is meant otherwise.

Finally, as used herein any reference to “one embodiment” or “some embodiments” means that a particular element, feature, structure, or characteristic described in connection with the embodiment is included in at least one embodiment disclosed herein. The appearances of the phrase “in some embodiments” in various places in the specification are not necessarily all referring to the same embodiment, and embodiments may include one or more of the features expressly described or inherently present herein, or any combination of or sub-combination of two or more such features, along with any other features which may not necessarily be expressly described or inherently present in the instant disclosure.

Often aircraft cabins utilize a variety of aircraft seat sizes throughout the aircraft cabin due to spacing constraints within the cabin. Due to the variety of aircraft seat sizes, different tray table designs are needed for each aircraft seat. For example, changing the width of a typical in-flight entertainment (IFE) seatback requires the multiple components on the IFE device and associated tray table to be adjusted based on the change in width. To manufacture all the components required for tray tables of different widths, manufacturing becomes more complicated, and costs increase.

As such, there is a need for a modular seatback tray table module, which cures one or more shortfalls of the previous approaches. The modular seatback tray table module may include a deployable tray table configured to mount to a seatback (e.g., a fixed seatback) without the need for conventional tray table legs. The modular design of the seatback table module should provide a singular central mounting unit that can be easily adapted to be used on a variety of seat sizes. For example, the same modular seatback tray table module may be coupled to a seatback having a variety of widths. In one instance, the modular seatback tray table module may be coupled to a wide seat (e.g., an exit row seat). In another instance, the modular seatback tray table module may also be coupled to a narrow seat (e.g., a seat at the back of the plane). The modular seatback tray table module should reduce the number of manufacturing changes needed to accommodate different aircraft seatback designs (e.g., seatback width changes, and the like). The modular seatback tray table module may include a personal electronic device (PED) holder configured to support one or more user devices (e.g., mobile phones, tablets, phablets, or the like).

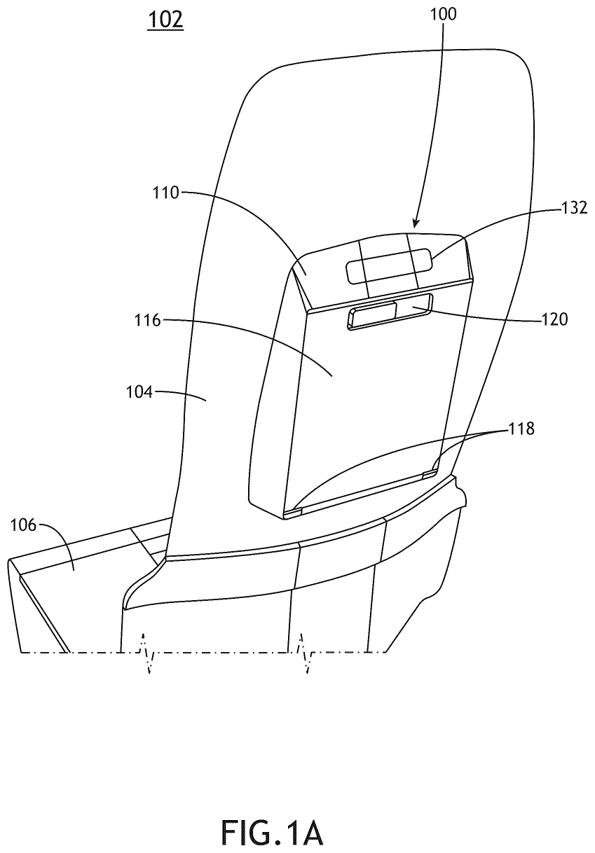

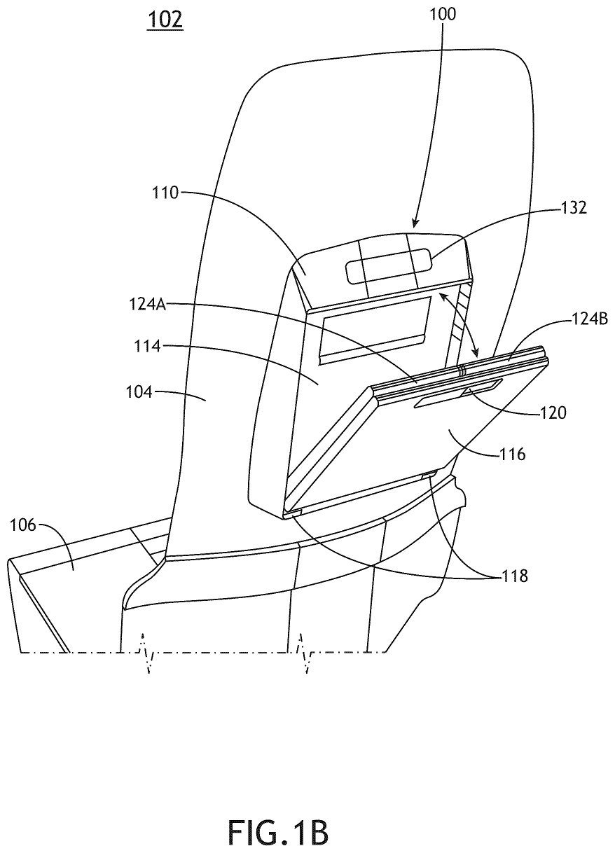

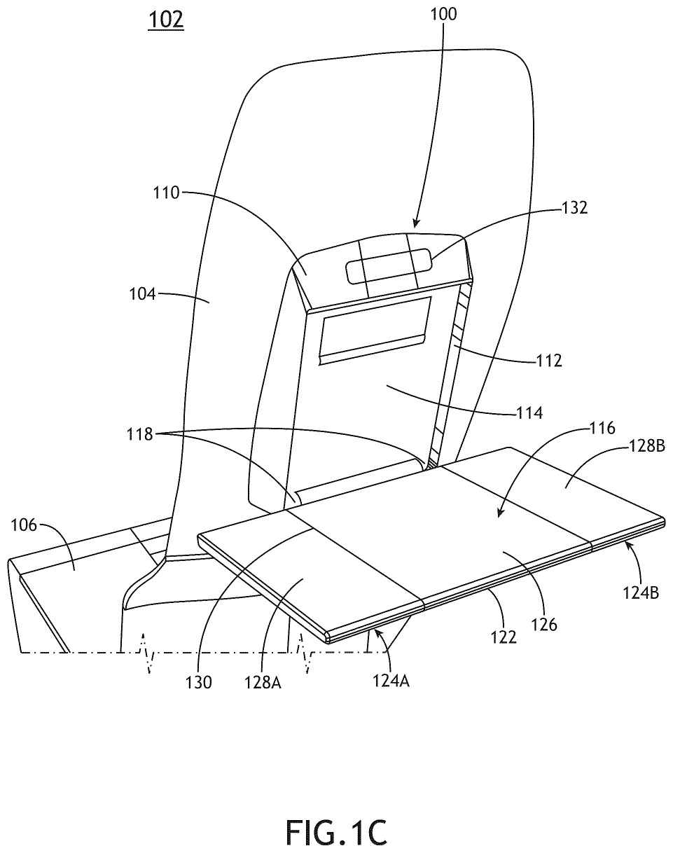

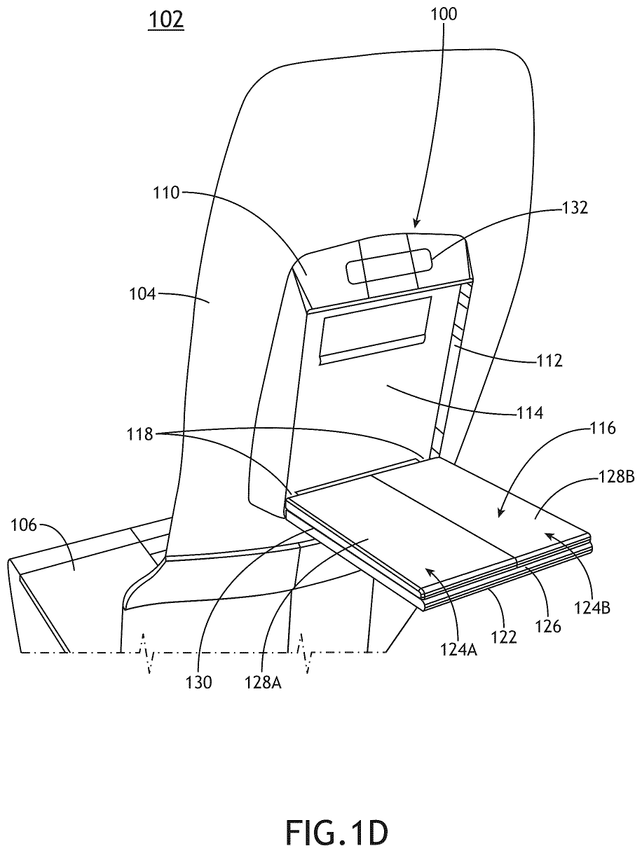

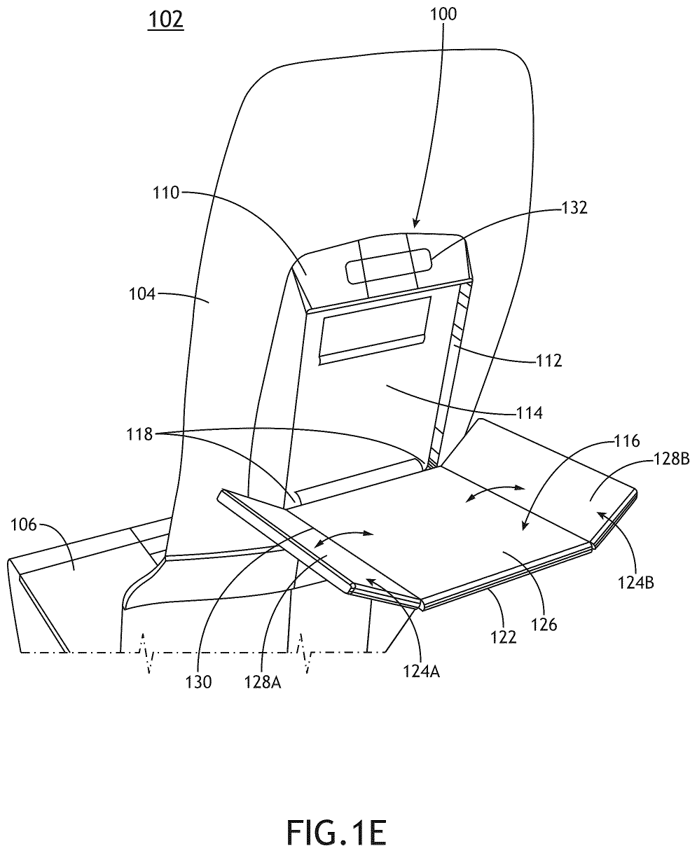

FIGS. 1A-1E generally illustrate simplified schematics of a modular seatback tray table module 100, in accordance with one or more embodiments of the disclosure. It is noted herein that the term “modular seatback tray table module”, “seatback tray table module,” and variants thereof may be considered equivalent for purposes of the present disclosure, unless otherwise noted herein.

The modular seatback tray table module 100 may be coupled to an aircraft seat 102. For example, the modular seatback tray table module 100 may be coupled to a seatback 104 of the aircraft seat 102. For instance, the modular seatback tray table module 100 may be coupled to rear surface of a fixed seatback 104. The fixed seatback 104 of the aircraft seat 102 may be in a stationary, or fixed position. In this regard, a passenger occupying the aircraft seat 102 may be prevented from reclining the seatback 104. It is contemplated herein that by coupling the modular seatback tray table module 100 to the rear surface of the fixed seatback 104, the modular seatback tray table module 100 is able to be mounted in a singular position as a module without the use of conventional tray table legs, as will be discuss further herein.

The modular seatback tray table module 100 may include a body 110. For example, the body 110 of the modular seatback tray table module 100 may be configured to couple to the rear surface of the fixed seatback 104 of the aircraft seat 102.

It is completed herein that the body 110 of the modular seatback tray table module 100 may be mounted or coupled to the seatback 104 of the aircraft seat 102 via any suitable mechanism. For example, the body 110 of the modular seatback tray table module 100 may be mounted to the seatback 104 of the aircraft seat 102 via one or more fasteners. For instance, the one or more fasteners may include any suitable fastener such as, but not limited to, one or more bolts, screws, or the like. By way of another example, the body 110 of the modular seatback tray table module 100 may be mounted to the aircraft seat 102 via an adhesive. For instance, the one or more adhesives may include any suitable adhesive such as, but not limited to, epoxy, polyurethane, dry firm glues, or the like. Further, the body 110 of the modular seatback tray table module 100 may be mounted to the aircraft seat 102 via a combination of one or more fasteners and/or one or more adhesives. By way of another example, the body 110 of the modular seatback tray table module 100 may be integrated with the aircraft seat 102. For instance, the body 110 of the modular seatback tray table module 100 may be integrated with the fixed seatback 104 of the aircraft seat 102.

The body 110 of the modular seatback tray table module 100 may be coupled to aircraft seats having different widths. For example, the body 110 of the modular seatback tray table module 100 may be coupled to the seatback 104 of a wide aircraft seat (e.g., an exit row seat). By way of another example, the body 110 of the modular seatback tray table module 100 may be coupled to the seatback 104 of a narrow aircraft seat (e.g., a seat at the back of the plane). As previously noted herein, the body 110 of the modular seatback tray table module 100 may not need to be adjusted for use between aircraft seats of different sizes/widths.

The aircraft seat 102 may include the seatback 104 and a seat pan 106. The aircraft seat 102 may include one or more armrests. The seatback 104 may include a headrest. For example, the headrest may be integrated within the seatback 104. By way of another example, the headrest may be a separate component coupled to (or inserted into) the seatback 104. For instance, the headrest may be movable relative to the seatback frame of the aircraft seat 102 (e.g., adjustable, removable, or the like).

The aircraft seat 102 may include a seat frame. The seat frame may include, but is not limited to, a seatback frame, a seat pan frame, and a base assembly. One or more of the seatback frame and/or the seat pan frame may be directly coupled, or indirectly coupled via one or more interconnecting components, to one or more components of the seat frame. At least a portion of the shroud (e.g., the bucket shroud section of the shroud) may be configured to cover the seat pan frame.

The aircraft seat 102 may include a base assembly. The base assembly may include one or more base rails (e.g., tubes, bars, or the like). For example, the one or more base rails may be positioned relative to a particular direction of travel of the aircraft seat 102 including, but not limited to, perpendicular (e.g., cross-wise), parallel (e.g., cross-wise), or the like. For instance, the one or more base rails may be positioned relative to a same or a different direction of travel of the aircraft seat 102.

The base assembly may include one or more base brackets. For example, the one or more base rails may be coupled together via the one or more base brackets. For example, a base bracket may couple together the base rail and an adjacent base rail at any angle, such that the base assembly may include an outline of any geometric shape known in the art. For instance, the outline may be rectangular or substantially rectangular. Therefore, the above description should not be interpreted as a limitation on the present disclosure but merely an illustration.

The one or more base brackets may be coupled to a set of floor tracks of the aircraft cabin via one or more floor fittings. At least a portion of the shroud (e.g., the base shroud section of the shroud) may be configured to cover the base assembly.

Although FIGS. 1A-1E depict the modular seatback tray table module 100 being coupled to a single aircraft seat 102, it is contemplated herein that the modular seatback tray table module 100 may be coupled to a row of aircraft seats, where the row of aircraft seats includes any number of individual aircraft seats 102. In such example, the body 110 of the modular seatback tray table module 100 may be configured to couple to each individual aircraft seat 102 within the row of aircraft seats (regardless of widths of said aircraft seats 102).

Referring to FIGS. 1B-1C, the body 110 may include a plurality of internal walls 112 that at least partially define an interior cavity 114. For example, at least one wall 112 of the plurality of internal walls 112 may connect to at least one additional internal wall 112 at one end and connect to at least one additional internal wall at another end, forming an interior cavity 114 (or hollow gap) in the body 110. In a non-limiting example, as shown in FIGS. 1B-1C, the body 110 may include four internal walls 112, forming a quadrilateral shaped (e.g., rectangular) interior cavity 114 within the body 110.

Referring to FIGS. 1C-1E, the modular seatback tray table module 100 may include a deployable tray table 116. The deployable tray table 116 may be configured to actuate between at least a tray table stowed position and a tray table deployed position. For example, FIG. 1A shows the deployable tray table 116 in the stowed position. By way of another example, FIG. 1C shows the deployable tray table 116 in the deployed position. The deployable tray table 116 may also be in an intermediate position when actuating between at least one of the tray table stowed position and the tray table deployed position, and vice versa, as shown in FIG. 1B.

It is noted herein that a stowed or raised position may be considered a taxi, takeoff, or landing (TTL) position during select stages of flight (though the stowed or raised position is not limited to use during the select stages of flight as the TTL position, but also may be used at any point during the flight), for purposes of the present disclosure. In addition, it is noted that any position that does not meet the above-defined requirements of the TTL position may be considered a non-TTL position, for purposes of the present disclosure. Further, it is noted the deployable tray table 116 may be actuatable (e.g., translatable and/or rotatable) from the TTL position to a non-TTL position, and/or vice versa. Therefore, the above description should not be interpreted as a limitation on the present disclosure but merely an illustration.

When in the tray table stowed position, at least a portion of the interior cavity 114 may be configured to receive at least a portion of the deployable tray table 116. For example, when in the stowed position, the deployable tray table 116 may be dimensioned to substantially fit within the interior cavity 114 and rest substantially flush with the body 110.

The modular seatback tray table module 100 may include one or more tray table actuation members 118. For example, the one or more tray table actuation members 118 may be configured to actuate the deployable tray table 116 between at least one of the tray table stowed position and the tray table deployed position.

The one or more tray table actuation members 118 may configured to couple to one or more mount points integrated within the body 110. For example, the one or more mount points may be integrated at a bottom edge of the interior cavity 114. For instance, two mount points may be integrated at the bottom edge of the interior cavity 114. In this regard, a first mount point may be integrated on a first side (e.g., the right side) of the bottom edge of the interior cavity 114 and a second mount point may be integrated on a second side (e.g., the left side) of bottom edge of the interior cavity 114. It is contemplated herein that the one or more tray actuation members 118 may be configured to couple to the one or more mount points, coupling the deployable tray table 116 to the body 110 without the use of conventional tray table legs.

It is contemplated herein that the tray table actuation members 118 may include any type of actuation member suitable for actuating the deployable tray table 116. For example, the tray table actuation members 118 may include one or more electro-mechanical actuators, linear/rotary actuators, or the like. For instance, the tray table actuation members 118 may include one or more rotary actuators. In this regard, the one or more rotary actuators may include, but are not limited to, friction hinges, self-closing hinges, spring-loaded hinges, or the like.

The deployable tray table 116 may actuate about an axis defined by the tray table actuation members 118. For example, the deployable tray table 116 may rotate about the axis of the tray table actuation members 118 between at least one of the tray table stowed position and the tray table deployed position. For instance, when hinges are used as tray table actuation members 118, the deployable tray table 116 may actuate about a hinge axis between at least one of the tray table stowed position and the tray table deployed position.

Referring to FIG. 1A, the deployable tray table 116 may include one or more tray table locks 120. The one or more tray table locks 120 may be configured to stow the deployable tray table 116 in the tray table stowed position. For example, the one or more tray table locks 120 may prevent the deployable tray table 116 from actuating from the stowed position to the deployed position. It is contemplated herein that aviation guidelines and/or standards may require the deployable tray table 116 to be in locked in the stowed (or TTL) position during select stages of the flight. Further, the one or more tray table locks 120 may secure the deployable tray table 116 in the stowed position should the aircraft experience turbulence, or the like.

The one or more tray table locks 120 may include any type of tray table lock. For example, as shown in FIG. 1A, the one or more tray table locks 120 may include a slidable latch coupled to or (or integrated with) at least one of the body 110 or the deployable tray table 116. In this regard, the slidable latch may stow the deployable tray table 116 within the tray table stowed position, where the slidable latch may be configured to translate (or slide) to allow the deployable tray table 116 to actuate to the deployed tray table position. It is contemplated herein that the slidable latch may be Head Injury Criteria (HIC) compliant. For instance, the slidable latch may be positioned away from the nose of the passenger, minimizing HIC issues. Although FIG. 1A depicts a slidable latch, it is contemplated herein that the one or more tray table locks 120 may include any type of lock member including, but not limited to, a rotating latch, an interlocking pin-and-groove assembly, or the like.

The deployable tray table 116 may rotate from the stowed position to an approximately horizonal position associated with the deployed position. For example, when in the deployed position, the deployable tray table 116 may form a horizontal, planar surface. The planar surface may allow for objects (e.g., drinks, laptops, or books) to be placed on the deployable tray table 116 without sliding off. For example, when in the deployed position, the deployable tray table 116 may be used as a small ledge used to hold smaller objects (e.g., drinks, literature, small personal devices).

Referring to FIGS. 1C-1E, the deployable tray table 116 may include a primary section 122 and one or more deployable extension members coupled to the primary section 122. In a non-limiting example, the one or more deployable extension members may include at least a first deployable extension member 124A and a second deployable extension member 124B. For instance, the primary section 122 may be coupled to the first extension member 124A on a first side (e.g., left side) and the second extension member 124B on a second side (e.g., right side) opposite the first side. In this regard, the primary section 122, the first deployable extension member 124A, and the second deployable extension member 124B may form the planar surface. It is contemplated herein that FIGS. 1C-1E are provided merely for illustrative purposes and shall not be construed as limiting the scope of the present disclosure. For example, the deployable tray table 116 may include any number of deployable extension members. In one non-limiting example, the deployable tray table 116 may include only a first extension member 124A (or second extension member 124B). In another non-limiting example, the deployable tray table 116 may include only a primary section 122, with no extension members 124A, 124B.

The primary section 122 may include at least a top primary surface 126. Each of the one or more deployable extension members 124A, 124B may include an auxiliary surface. For example, as shown in FIG. 1C, the deployable tray table 116 may include the first deployable extension member 124A with a first auxiliary surface 128A arranged proximate to (or next to) the primary surface 126. By way of another example, as shown in FIG. 1C, the deployable tray table 116 may include the second deployable extension member 124B with a second auxiliary surface 128B arranged proximate to (or next to) the primary surface 126. In this regard, the top primary surface 126, the first auxiliary surface 128A, and the second auxiliary surface 128B may form the planar surface, such that passengers may use said surface to hold one or more passenger items (e.g., drinks, foods, laptops, literature (e.g., magazines, books, or the like), or the like).

The one or more deployable extension members 124A, 124B may be coupled to the primary section 122 via one or more table actuators 130. For example, the one or more deployable extension members 124A, 124B may be configured to actuate between at least a first position and a second position via the one or more table actuators 130. For instance, the one or more deployable extension members 124A, 124B may be configured to actuate between a stowed configuration associated with the first position and a deployed configuration associated with the second position via the one or more table actuators 130.

The one or more table actuators 130 may be any mechanical device suitable for actuating the one or more deployable extension members 124A, 124B between at least the first position and the second position. For example, the one or more table actuators 130 may include one or more electro-mechanical actuators, linear/rotary actuators, or the like. In a non-limiting example, the one or more table actuators 130 may be one or more hinges. For instance, the one or more hinges may include, but are not limited to, friction hinges, self-closing hinges, spring-loaded hinges, or other hinges.

When in the first position, as shown in FIG. 1D, the positioning of the one or more deployable extension members 124A, 124B may permit the deployable tray table 116 to actuate between the tray table stowed position and tray table deployed position. Further, when in the first position, at least the first auxiliary surface 128A and the second auxiliary surface 128B may be adjacent to at least the primary surface 126. For example, when the one or more deployable extension members 124A, 124B are in the first position, the first auxiliary surface 128A and the second auxiliary surface 128B may rest on the primary surface 126. The deployable tray table 116 may then actuate into the stowed position, such that the interior cavity 114 may be configured to receive at least a portion of the one or more deployable extension members 124A, 124B and the primary section 122.

When the deployable tray table 116 is in the tray table deployed position, the auxiliary surfaces 128A, 128B of the deployable extension members 124A, 124B may be actuated to the second position. For example, when in the second position, the auxiliary surfaces 128A, 128B of the one or more deployable extension members 124A, 124B may sit on a substantially similar plane as the primary surface 126. In this regard, the auxiliary surfaces 128A, 128B and primary surface 126 may form a wide tray table surface. For example, the primary surface 126 may be on a horizontal plane. Further, when in the second position, the one or more auxiliary surfaces 128A, 128B may also sit on the horizontal plane.

The one or more deployable extension members 124A, 124B may actuate between the first and the second position while the deployable tray table 116 is in the tray table deployed position. In a non-limiting example, the one or more deployable extension members 124A, 124B may rotate about a second axis, until reaching the second position. By way of another non-limiting example, the one or more deployable extension members 124A, 124B may rotate about a second axis from the second position to the first position. The second axis that the one or more deployable extension members 124A, 124B rotate about may be defined by the one or more table actuators 130. By way of another example, as shown in FIG. 1E, the one or more deployable extension members 124A, 124B may be in an intermediate position while actuating between the first position and second position.

It is contemplated herein that the first extension member 124A may actuate independently of the second extension member 124B. For example, the first extension member 124A may be in the second position while the second extension member 124B is in the first position. The second extension member 124B may actuate independently of the first extension member 124A. For example, the second extension member 124B may be in the second position while the first extension member 124A is in the first position. By way of another example, the first extension member 124A and second extension member 124B may both be in the second position.

The deployable tray table 116 may include one or more indentations for cups, bottles, or other containers. For example, the primary surface 126 may include one or more indentations. By way of another example, the one or more auxiliary surfaces 128A, 128B may include one or more indentations. The deployable tray table 116 may include a non-slip laminate or coating.

The deployable tray table 116 may be used as a small ledge used to hold smaller objects (e.g., drinks, literature, small personal devices) when at least one of the one or more deployable extension members 124A, 124B is in the first position. For example, the planar surface of the deployable tray table 116 may be used as a small ledge when at least one of the first extension member 124A or the second extension member 124B are in the first position. For instance, the small ledge may be used when both the first extension member 124A and the second extension member 124B are in the first position.

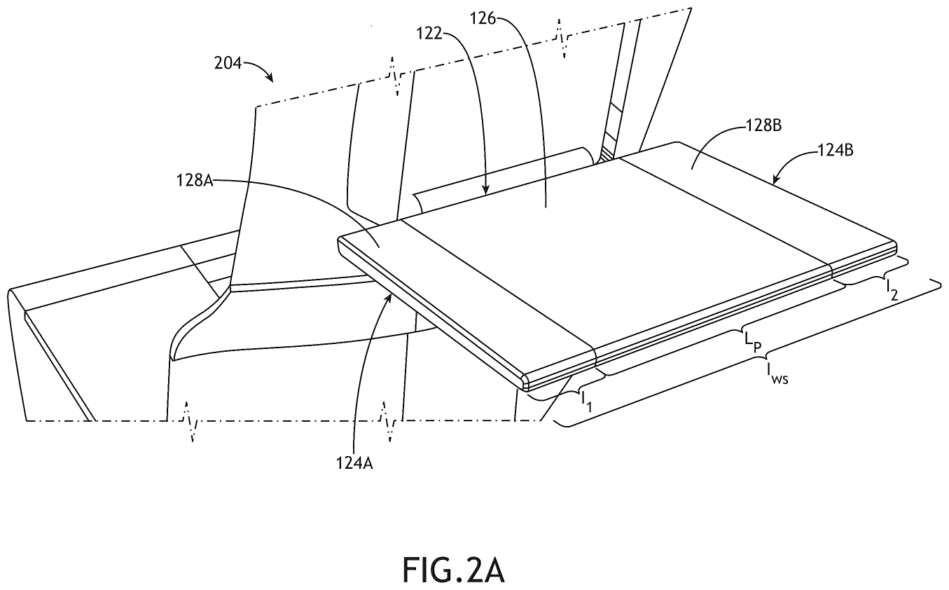

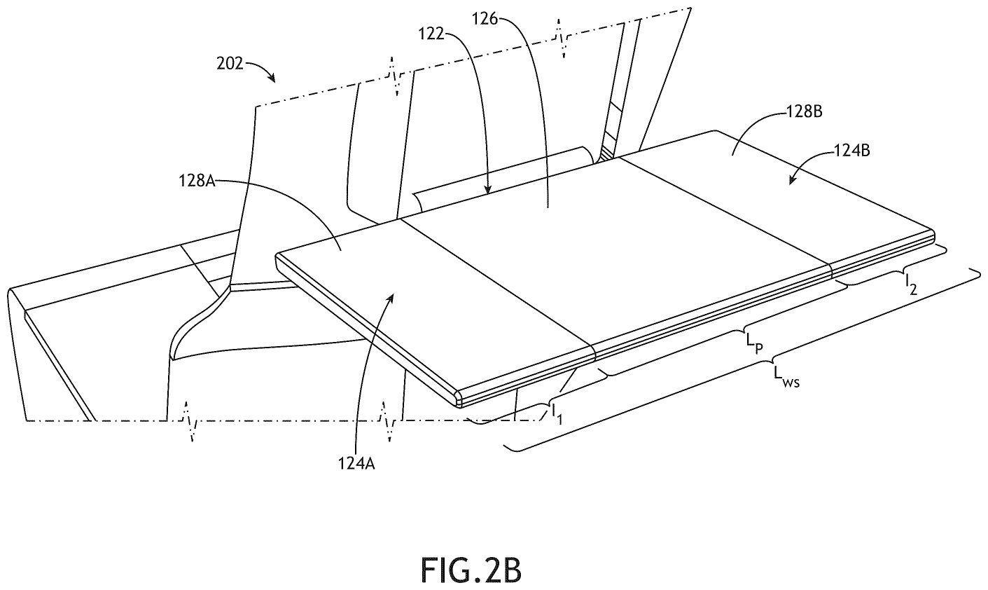

FIGS. 2A-2B illustrate simplified schematics of a deployable tray table of the modular seatback tray table module 100 in the deployed tray table position with two deployable extension members in the second position, in accordance with one or more embodiments of the disclosure.

The primary section 122 may be associated with a length, Lₚ. Each of the one or more deployable extension members 124A, 124B may further be associated with a length. For example, as illustrated in FIG. 2A, the first deployable extension member 124A may have a length l₁ and the second deployable extension member 124B may have a length l₂. By way of another example, when both the first deployable extension member 124A and the second deployable extension member 124B are in the second position, the resulting wide tray table surface may have a length equal to the sum of Lₚ, l₁, and l₂, herein referred to as l_{ws}.

It is contemplated herein that l_{ws} may be configured by changing any of the lengths Lₚ, l₁, or l₂. For example, increasing the length of any one of Lₚ, l₁, or l₂ may cause an increase in l_{ws}. By way of another way of another example, decreasing the length of any one of Lₚ, l₁, or l₂ may cause a decrease of the length of l_{ws}.

The length of l_{ws} may be configured to be substantially proportional to the length of the aircraft seat 102 to which the modular seatback tray table module 100 is coupled. The length of the aircraft seat 102 may be defined by the length of widest portion of the aircraft seat 102. For example, the widest portion of aircraft seat 102 may be the length of the seatback 104. It is contemplated herein that l_{ws} may be equal to the length of the widest portion of the aircraft seat 102. It is further contemplated that l_{ws} may be less to the length of the widest portion of the aircraft seat 102.

The length of l_{ws} may be configured by the length of the one or more deployable extension members 124A, 124B. For example, a wide aircraft seat 202 (e.g., an exit row) may be coupled to a modular seatback tray table module 100 with one or more deployable extension members 124A, 124B which have a longer length when compared to a less wide aircraft seat 204 (e.g., a seat at the back of the aircraft). For instance, the wide aircraft seat 202 may include a first deployable extension member 124A with a length of L₁ and a second deployable extension member 124B with a length of L₂. The less wide aircraft seat 204 may include a first deployable extension member 124A with a length of l₁ and a second deployable extension member 124B with a length of l₂ with L₁ being longer than l₁ and L₂ being longer than l₂. The length of the primary section 122 may remain the same between the wide aircraft seat 202 and the less wide aircraft seat. The modular seatback tray table module 100 of the wide aircraft seat 202 may provide a longer length of the wide tray table surface without changing the components of the body 110 or the primary section 122.

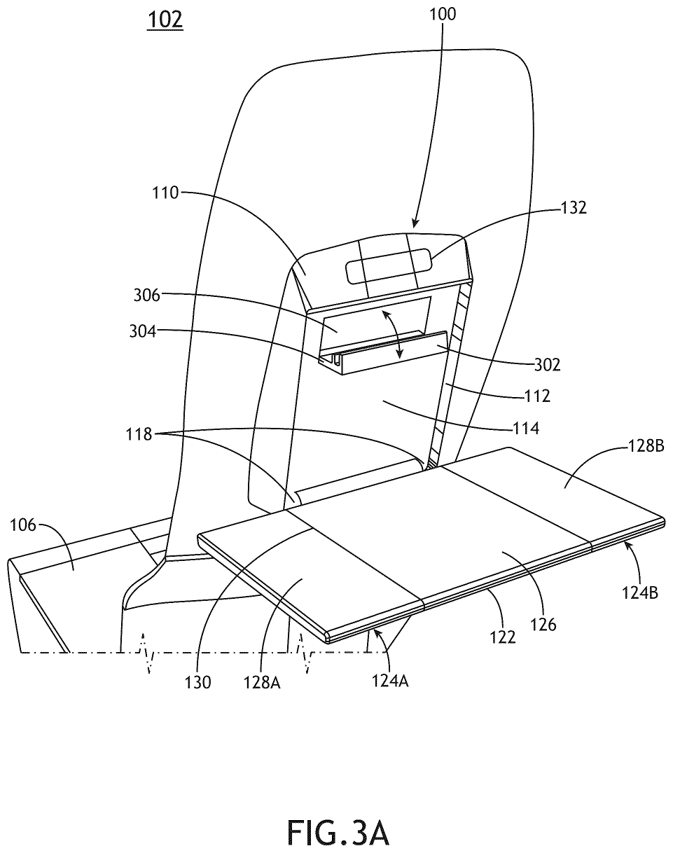

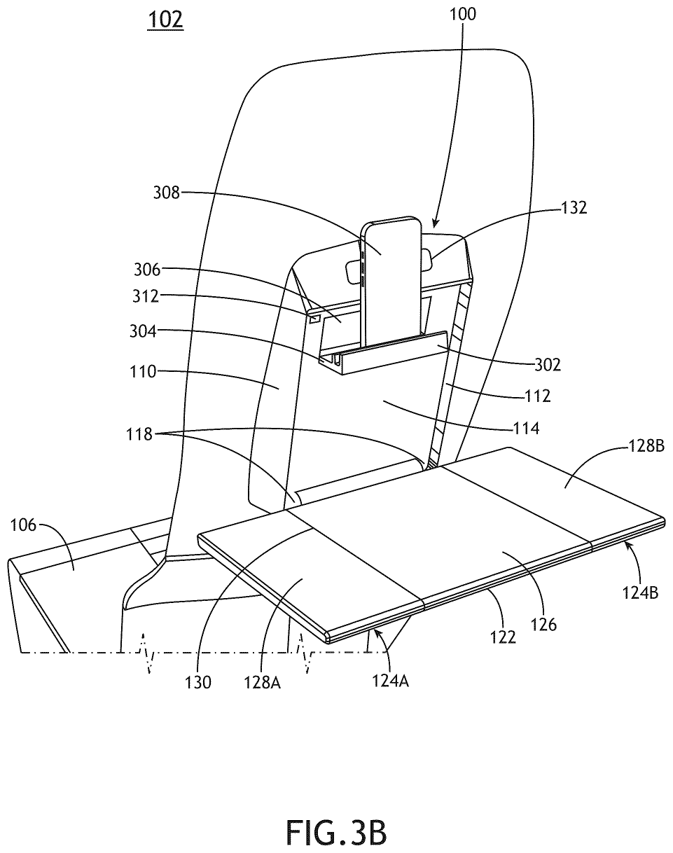

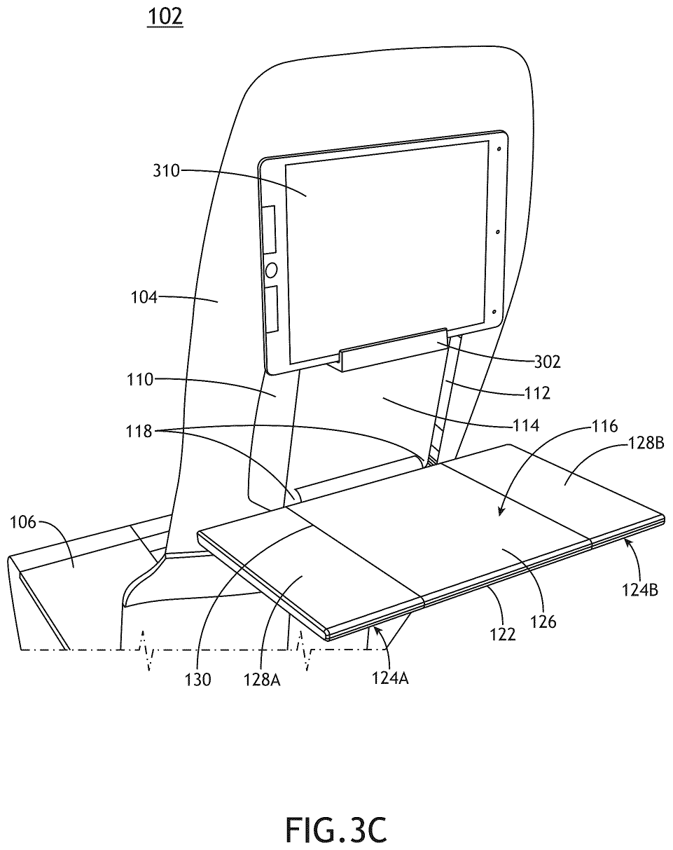

FIGS. 3A-3C illustrate the modular seatback tray table module 100 including a personal electronic device support 302, in accordance with one or more embodiments of the disclosure.

The modular seatback tray table module 100 may include a personal electronic device (PED) support 302. The PED support 302 may be configured to hold/support one or more PEDs, where the one or more PEDs may be viewed without being held by a passenger. The PED support 302 may be coupled to the modular seatback tray table module 100. For example, as shown in FIG. 3A, the PED support 302 may be coupled to the body 110 of the modular seatback tray table module 100. By way of another example, the PED support 302 may be coupled to the deployable tray table 116.

The PED support 302 may actuate between a support stowed position and a support deployed position. For example, the PED support 302 may rotate about an axis through one or more support members 304 between the support stowed position and the support deployed position.

The one or more support members 304 may be any mechanical device with the capability to actuate the PED support 302 between a support stowed position and a support deployed position. For example, one or more support members 304 may include one or more electro-mechanical actuators, linear/rotary actuators, or the like. In embodiments, the one or more support members 304 may be one or more hinges. For example, the one or more hinges may include, but are not limited to, friction hinges, self-closing hinges, spring-loaded hinges, or other hinges.

The PED support 302 may be configured to fit within an indentation 306 set within a thickness of the modular seatback tray table module 100 when in the support stowed position. For example, a back or rear surface of the PED support 302 may be flush with a surface of the body 110 formed by the interior cavity when the PED support 302 rests within the indentation 306 when in the support stowed position. For another example, a back or rear surface of the PED support 302 may be flush with a surface of the deployable tray table 116 when the PED support 302 rests within the indentation 306 when in the support stowed position.

The PED support 302 may actuate to create a support surface. The support surface may be used to hold a variety of objects. For example, the PED support 302 may be configured to hold a PED when the PED support 302 is in the support deployed position.

The PED support 302 may be coupled to the body 110 of the modular seatback tray table module 100. For example, a back or rear surface of the PED support 302 may be flush with a surface of the body 110 formed by the interior cavity 114 when the PED support 302 rests within the indentation 306 when in the support stowed position. In this regard, by the PED support 302 resting within the indentation 306 and being flush with the surface of the body 110, the deployable tray table 116 may actuate between the deployed position and the stowed position.

It is contemplated herein that the PED support 302 may support any type of PED. For example, as shown in FIG. 3B, the PED support 302 may be configured to hold a mobile phone 308. For instance, the PED support 302 may support the mobile phone 308 on the support surface while the PED support 302 is in the support deployed position, in such a way that a passenger may view the mobile phone 308 without holding the mobile phone 308. By way of another example, as shown in FIG. 3C, the PED support 302 may be configured to hold a tablet 310. For instance, the PED support 302 may support the tablet 310 on the support surface while the PED support 302 is in the support deployed position, in such a way that a passenger may view the tablet 310 without holding the tablet 310.

The modular seatback tray table module 100 may also include one or more universal serial bus (USB) ports 312. The one or more USB ports 312 may be integrated with modular seatback tray table module 100 in a variety of configurations. For example, the USB port 312 may be integrated into the body 110 of the modular seatback tray table module 100. By way of another example, the USB port 312 may be integrated into the deployable tray table 116. The USB port 312 may be used to charge one or more electronic devices. For instance, the USB port 312 may charge the one or more PEDs (e.g., a mobile phone 308, a tablet 310, or the like).

The USB port 312 may be integrated in proximity with the PED support 302. In this regard, such configuration may allow a passenger to connect a charging cable between the USB port 312 and the PED being held by the PED support 302.

The modular seatback tray table module 100 may include alternative charging solutions. For example, the modular seatback tray table module 100 may have integrated charging plates configured to wirelessly charge the PED. In one instance, the deployable tray table 116 may include integrated charging plates configured to wirelessly charge the PED. In another instance, the body 110 may include integrated charging plates configured to wirelessly charge the PED. By way of another example, the modular seatback tray table module 100 may include alternative ports, such as an electric outlet, or the like.

Referring back to FIGS. 1A-1B, the modular seatback tray table module 100 may also include an information panel 132. The information panel 132 may provide information to a passenger. The information panel 132 may be a display screen. For example, the display screen may be at least one of a Liquid Crystal Display (LCD), Light-Emitting Diode (LED), Organic Light-Emitting Diode (OLED) or the like.

The information panel 132 may display one or more graphical icons. For example, the one or more graphic icons may represent information that may be interpreted by a passenger. For instance, the graphic icons may include at least one of a fasten seatbelt icon, a no smoking icon, wireless fidelity (Wi-Fi) icon, flight status icon, seat location icon, or the like.

The information panel 132 may be positioned on the modular seatback tray table module 100 in a manner which permits the information panel 132 to be viewed by a passenger of an aircraft seat 102 while the deployable tray table 116 is in the tray table stowed position. For example, a passenger can view the information panel 132 during takeoff, taxi, and landing when the deployable tray table 116 is required to be in the stowed position.

Although embodiments of the disclosure illustrate an actuation from respective stowed positions to respective various deployed positions for the various components of the deployable tray table 116, it is noted herein similar motions may occur in reverse between the respective various deployed positions and the respective stowed positions for the various components of the deployable tray table 116. Therefore, the above description should not be interpreted as a limitation on the scope of the disclosure but merely an illustration.

The modular seatback tray table module 100 installed within an avionics environment may be configured in accordance with aviation guidelines and/or standards put forth by, but not limited to, the Federal Aviation Administration (FAA), the European Aviation Safety Agency (EASA), or any other flight certification agency or organization.

Although embodiments of the disclosure are directed to an avionics environment, it is noted herein the modular seatback tray table module 100 is not limited to the avionics environment and/or the aircraft components within the avionics environment. For example, the modular seatback tray table module 100 may be configured to operate in any type of vehicle known in the art. For example, the vehicle may be any air, space, land, or water-based personal equipment or vehicle; any air, space, land, or water-based commercial equipment or vehicle; any air, space, land, or water-based military equipment or vehicle known in the art. For instance, the vehicle may include an automobile. By way of another example, the modular seatback tray table module 100 may be coupled to and/or configured to operate with an apparatus sold for commercial or industrial use in either a home or a business. Therefore, the above description should not be interpreted as a limitation on the present disclosure but merely an illustration.

Although the disclosure has been described with reference to the embodiments illustrated in the attached drawing figures, equivalents may be employed and substitutions made herein without departing from the scope of the claims. Components illustrated and described herein are merely examples of a system/device and components that may be used to implement embodiments of the disclosure and may be replaced with other devices and components without departing from the scope of the claims. Furthermore, any dimensions, degrees, and/or numerical ranges provided herein are to be understood as non-limiting examples unless otherwise specified in the claims.

What is claimed:

1. A modular seatback tray table module comprising:
a modular body including a plurality of internal walls, wherein the plurality of internal walls at least partially defines an interior cavity;
a deployable tray table configured to actuate between at least one of a tray table stowed position and a tray table deployed position, wherein at least a portion of the interior cavity of the modular body is configured to receive at least a portion of the deployable tray table when the deployable tray table is in the tray table stowed position; and
one or more tray table actuation members configured to couple to one or more mount points on the modular body, wherein the one or more tray table actuation members are configured to actuate the deployable tray table between at least one of the tray table stowed position and the tray table deployed position.

2. The modular seatback tray table module of claim 1, wherein the modular body of the modular seatback tray table module is configured to be mounted to a portion of a seatback of an aircraft seat.

3. The modular seatback tray table module of claim 2, wherein the seatback of the aircraft seat includes a fixed seatback.

4. The modular seatback tray table module of claim 1, wherein the one or more tray table actuation members include one or more hinges, wherein the deployable tray table is configured to actuate about a hinge axis between at least one of the tray table stowed position and the tray table deployed position.

5. The modular seatback tray table module of claim 1, wherein the deployable tray table comprises:
a primary surface and one or more auxiliary surfaces.

6. The modular seatback tray table module of claim 5, wherein the one or more auxiliary surfaces include one or more deployable extension members, wherein the one or more deployable extension members include one or more table actuators configured to couple the one or more deployable extension members to the primary surface.

7. The modular seatback tray table module of claim 6, wherein the one or more deployable extension members are configured to actuate between at least one of a first position and a second position about a second axis of the one or more table actuators to form a wide tray table surface.

8. The modular seatback tray table module of claim 7, wherein the one or more deployable extension members comprise a plurality of deployable extension members, wherein the plurality of deployable extension members includes at least a first extension member and a second extension member.

9. The modular seatback tray table module of claim 8, wherein a length of the first extension member and a length of the second extension member are configured to cause a length of the wide tray table surface of the deployable tray table to be substantially proportional to a length of a seatback of an aircraft seat.

10. The modular seatback tray table module of claim 1, further comprising:
a personal electronic device support configured to actuate between at least one of a support stowed position and a support deployed position via one or more support actuators.

11. The modular seatback tray table module of claim 10, wherein the modular body of the modular seatback tray table module further comprises an indentation set within the modular body, wherein at least a portion of the indentation is configured to receive at least a portion of the personal electronic device support when the personal electronic device support is in the support stowed position,
wherein the personal electronic device support sits substantially flush with a surface of the modular body of the modular seatback tray table module when in the support stowed position.

12. The modular seatback tray table module of claim 10, wherein the personal electronic device support is configured to hold a personal electronic device when the personal electronic device support is in the support deployed position.

13. The modular seatback tray table module of claim 12, wherein the personal electronic device includes at least one of a mobile phone or a tablet.

14. The modular seatback tray table module of claim 1, further comprising:
one or more tray table locks configured to stow the deployable tray table in the tray table stowed position.

15. The modular seatback tray table module of claim 14, wherein the one or more tray table locks comprise one or more slidable latches.

16. The modular seatback tray table module of claim 1, wherein at least one of the modular body of the modular seatback tray table module or the deployable tray table includes one or more universal serial bus ports.

17. The modular seatback tray table module of claim 1, wherein at least one of the modular body of the modular seatback tray table module or the deployable tray table includes an information panel.

18. The modular seatback tray table module of claim 17, wherein the information panel includes a display screen configured to display one or more graphical icons.

19. The modular seatback tray table module of claim 18, wherein the one or more graphical icons include at least one of a fasten seatbelt icon, a no smoking icon, wireless fidelity, flight status, or seat location.

20. An aircraft seat comprising:
a seating section, the seating section including a seat pan and a seatback, wherein the seatback includes a fixed seatback; and
a modular seatback tray table module comprising:
a modular body including a plurality of internal walls, wherein the plurality of internal walls at least partially defines an interior cavity;
a deployable tray table configured to actuate between at least one of a tray table stowed position and a tray table deployed position, wherein at least a portion of the interior cavity of the modular body is configured to receive at least a portion of the deployable tray table when the deployable tray table is in the tray table stowed position; and
one or more tray table actuation members configured to couple to one or more mount points on the modular body, wherein the one or more tray table actuation members are configured to actuate the deployable tray table between at least one of the tray table stowed position and the tray table deployed position,
wherein the modular seatback tray table module is coupled to a rear surface of the fixed seatback.
